(19) United States
(12) Patent Application Publication
(10) Pub. No.: US 2026/0289862 A1
(43) Pub. Date: Sep. 24, 2026

(54) VIDEO GENERATION METHOD AND APPARATUS, ELECTRONIC DEVICE AND STORAGE MEDIUM

(71) Applicant: Beijing Zitiao Network Technology Co., Ltd., Beijing (CN)

(72) Inventors: Zhipeng GE, Beijing (CN); Shuang LIANG, Beijing (CN); Tianshu HU, Beijing (CN); Longhao ZHANG, Beijing (CN)

(21) Appl. No.: 19/573,753

(22) Filed: Mar. 20, 2026

(30) Foreign Application Priority Data
Mar. 20, 2025 (CN) 202510337038.6

(51) Int. Cl. G06T 11/60; G06V 10/46; G06V 40/16

(52) U.S. Cl. CPC G06T 11/60; G06V 10/462; G06V 40/166

(57) ABSTRACT

A video generation method and apparatus, a device, and a medium are provided. The method includes: acquiring a first video including a target face, and a target audio; determining, based on the target audio, target key points in a target frame image corresponding to an original frame image in the first video; generating a first image and a second image corresponding to the original frame image based on the first video and the target key points, where the first image carries information of a complete facial region of the target face, and the second image carries information of an occluder corresponding to the target face; generating the target frame image corresponding to the original frame image based on the first image and the second image; and arranging the target frame images corresponding to respective original frame images in the first video, in sequence, to obtain a target video.

### CROSS-REFERENCE TO RELATED APPLICATION

The present application claims priority to Chinese Patent Application No. 202510337038.6, filed on Mar. 20, 2025, which is incorporated herein by reference in its entirety as a part of the present application.

### TECHNICAL FIELD

The present disclosure relates to the field of computer technologies, and in particular, to a video generation method and apparatus, an electronic device, and a storage medium.

### BACKGROUND

In scenarios such as multimedia editing, it may be necessary to replace an original audio of a person-speaking video with a new audio. The new audio used to replace the original audio may be, for example, an audio obtained by translating the original audio into a specified language, or may be an audio irrelevant to content of the original audio. In order to make a lip movement of the person in the video match the new audio so as to present a realistic effect that speaking content of the person in the video is exactly the content of the new audio, a face of the person in the original video is usually re-generated based on the new audio, so as to obtain a new video in which the lip movement of the person matches the new audio. However, the inventor(s) found that the existing video generation effect is not good, and problems such as degradation of facial generation quality are prone to occur, thus affecting user experience.

### SUMMARY

In order to solve the above technical problems or at least partially solve the above technical problems, the present disclosure provides a video generation method and apparatus, a device, and a medium.

An embodiment of the present disclosure provides a video generation method, including: acquiring a first video and a target audio, where the first video is a video including a target face; determining, based on the target audio, target key points in a to-be-generated target frame image corresponding to an original frame image in the first video, where the target key points are key points of a target face in the to-be-generated target frame image; generating a first image and a second image corresponding to the original frame image based on the first video and the target key points, where the first image carries information of a complete facial region of the target face, and the second image carries information of an occluder corresponding to the target face; generating the target frame image corresponding to the original frame image based on the first image and the second image corresponding to the original frame image; and arranging target frame images corresponding to respective original frame images in the first video, in sequence, to obtain a target video.

Optionally, the generating a first image and a second image corresponding to the original frame image based on the first video and the target key points includes: selecting a plurality of reference frame images from the first video, and acquiring reference key points of a target face in the reference frame images, where the target face in the reference frame images is fully unoccluded; fusing the plurality of reference frame images based on the target key points and the reference key points to obtain the first image; and generating the second image corresponding to the original frame image in the first video based on the target key points and the original frame image.

Optionally, the selecting a plurality of reference frame images from the first video includes: performing occluder detection processing on the first video to obtain an occluder detection result corresponding to the original frame image in the first video; selecting, based on the occluder detection result corresponding to the original frame image, an original frame image in which the target face is fully unoccluded as a candidate frame image; and selecting, based on lip movement information of the target face in the candidate frame image, a plurality of reference frame images with different lip movements from the candidate frame image.

Optionally, the fusing the plurality of reference frame images based on the target key points and the reference key points to obtain the first image includes: acquiring deformation information and weights respectively corresponding to the plurality of reference frame images based on the target key points and the reference key points, where the deformation information of the reference frame images is used to indicate a mapping relationship between the target face in the reference frame images and the target face in the target frame image corresponding to the reference frame images; performing grid sampling processing on the reference frame images based on the deformation information corresponding to the reference frame images to obtain deformed images corresponding to the reference frame images; and performing weighted fusion processing on the deformed images respectively corresponding to the plurality of reference frame images based on the weights respectively corresponding to the plurality of reference frame images to obtain the first image.

Optionally, the generating the second image corresponding to the original frame image in the first video based on the target key points and the original frame image includes: acquiring deformation information corresponding to the original frame image in the first video based on the target key points corresponding to the original frame image, where the deformation information is used to indicate a mapping relationship between the occluder in the original frame image and the occluder in the target frame image corresponding to the original frame image, and a mapping relationship between an unoccluded facial region in the original frame image and an unoccluded facial region in the target frame image corresponding to the original frame image; and performing grid sampling processing on the original frame image based on the deformation information corresponding to the original frame image to obtain the second image corresponding to the original frame image.

Optionally, the generating the target frame image corresponding to the original frame image based on the first image and the second image corresponding to the original frame image includes: acquiring a mask frame image corresponding to the original frame image, where the mask frame image is an image obtained by performing local masking processing on the target face in the original frame image; performing fusion processing based on the first image, the mask frame image corresponding to the original frame image, and the second image corresponding to the original frame image to obtain a fusion processing result; and obtaining the target frame image corresponding to the original frame image based on the fusion processing result.

Optionally, the performing fusion processing based on the first image, the mask frame image corresponding to the original frame image, and the second image corresponding to the original frame image to obtain a fusion processing result includes: extracting a target facial feature based on the first image and the mask frame image corresponding to the original frame image; extracting a specified feature based on the second image corresponding to the original frame image, where the specified feature includes at least an occluder feature; and performing multi-scale fusion processing on the target facial feature and the specified feature based on spatially adaptive normalization technology to obtain the fusion processing result.

Optionally, the performing multi-scale fusion processing on the target facial feature and the specified feature based on spatially adaptive normalization technology to obtain the fusion processing result includes: generating the fusion processing result based on the target facial feature and the specified feature by using a plurality of first networks and a plurality of second networks that are preset and connected in sequence, where the first networks and the second networks are all spatially adaptive normalization networks, input information of the first networks and the second networks both include the target facial feature, input information of a non-first first network further includes an output result of a previous network of the non-first first network, and input information of the second networks further includes an output result of a previous network of the second networks and the specified feature.

Optionally, the second image further carries information of an unoccluded facial region of the target face, and the specified feature further includes a feature of the unoccluded facial region of the target face.

Optionally, the fusion processing result is represented by a third image, and the obtaining the target frame image corresponding to the original frame image based on the fusion processing result includes: optimizing the third image to obtain the target frame image corresponding to the original frame image.

Optionally, the video generation method is performed by a preset target network model, and the target network model is obtained by training as follows: acquiring a sample video and a sample audio, and preprocessing the sample video, where the preprocessing includes at least one of: performing occluder adding processing on part of reference frame images corresponding to the sample video, and performing occluder adding processing on at least part of original frame images in the sample video; acquiring a first image and a target frame image generated by a preset initial generation model based on the sample audio and the preprocessed sample video; and performing supervised training based on the first image and the target frame image generated by the initial generation model to obtain the target network model based on the trained initial generation model.

An embodiment of the present disclosure further provides a video generation apparatus, including: an audio and video acquisition module, configured to acquire a first video and a target audio, where the first video is a video including a target face; a key point determination module, configured to determine, based on the target audio, target key points in a to-be-generated target frame image corresponding to an original frame image in the first video, where the target key points are key points of the target face in the to-be-generated target frame image; a first generation module, configured to generate a first image and a second image corresponding to the original frame image based on the first video and the target key points, where the first image carries information of a complete facial region of the target face, and the second image carries information of an occluder corresponding to the target face; a second generation module, configured to generate the target frame image corresponding to the original frame image based on the first image and the second image corresponding to the original frame image; and a video obtaining module, configured to arrange the target frame images corresponding to respective original frame images in the first video, in sequence, to obtain a target video.

An embodiment of the present disclosure further provides an electronic device, including: at least one processor, and a memory configured to store instructions that may be executed by the at least one processor, where the at least one processor is configured to read the instructions from the memory, and execute the instructions to implement the video generation method according to the embodiment of the present disclosure.

An embodiment of the present disclosure further provides a non-transient computer-readable storage medium, where a computer program is stored on the storage medium, and the computer program is configured to perform the video generation method according to the embodiment of the present disclosure.

An embodiment of the present disclosure further provides a computer program product, including a computer program, where the video generation method according to the embodiment of the present disclosure is implemented when the computer program is executed by at least one processor.

It should be understood that the content described in this section is neither intended to identify key or important features of the embodiments of the present disclosure, nor is used to limit the scope of the present disclosure. Other features of the present disclosure will become readily understood through the following description.

### BRIEF DESCRIPTION OF DRAWINGS

The drawings herein, which are incorporated in this specification and constitute a part thereof, illustrate the embodiments of the present disclosure and, together with the description, serve to explain the principles of the present disclosure.

In order to more clearly explain the technical solutions in the embodiments of the present disclosure or in the prior art, the following will briefly introduce the drawings that need to be used in the description of the embodiments or the prior art. Obviously, for those of ordinary skill in the art, other drawings may be obtained based on these drawings without paying creative efforts.

FIG. 1 is a schematic flowchart of a video generation method provided by an embodiment of the present disclosure;

FIG. 2 is a schematic structural diagram of a fusion network provided by an embodiment of the present disclosure;

FIG. 3 is a schematic flowchart of a video generation method provided by an embodiment of the present disclosure;

FIG. 4 is a schematic structural diagram of a video generation apparatus provided by an embodiment of the present disclosure; and

FIG. 5 is a schematic structural diagram of an electronic device provided by an embodiment of the present disclosure.

### DETAILED DESCRIPTION

In order to understand the above objectives, features and advantages of the present disclosure more clearly, the solutions of the present disclosure will be further described below. It should be noted that the embodiments of the present disclosure and the features in the embodiments may be combined with each other without conflict.

Many specific details are set forth in the following description to facilitate a full understanding of the present disclosure, but the present disclosure may also be implemented in other ways different from those described herein. Obviously, the described embodiments are part of the embodiments of the present disclosure, but not all of the embodiments.

The inventor(s) found that the existing video generation effect is poor, and problems such as degradation of facial generation quality are prone to occur, thus affecting user experience.

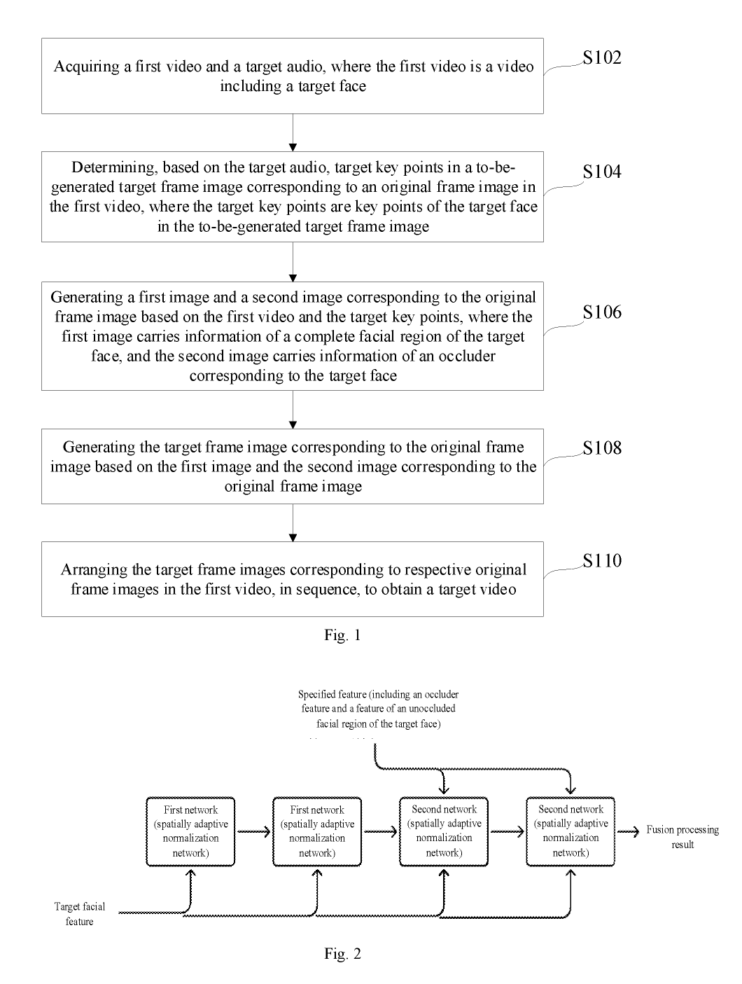

FIG. 1 is a schematic flowchart of a video generation method provided by an embodiment of the present disclosure. The method may be performed by a video generation apparatus, where the apparatus may be implemented by software and/or hardware, and may generally be integrated in an electronic device. As shown in FIG. 1, the method mainly includes the following steps S102 to S110.

Step S102: acquiring a first video and a target audio, where the first video is a video including a target face.

The target face may be, for example, a face of any target object having facial features, and the target object may be a real object such as a person, or may be a virtual object such as a doll or a digital human. The first video may be a speaking video of the target object, and when the target object is speaking, a lip movement of the target face usually changes. The target audio (also referred to as first audio) is a new audio that is desired to replace an original audio (i.e., speaking audio of the target object) in the first video. Content of the target audio is not limited in the embodiment of the present disclosure. For example, the target audio is an audio obtained by translating an audio in the first video into a specified language, that is, the target audio is an audio related to content of the first video. For example, the first video is originally a video in which a user A speaks in a language A, and the target audio is an audio obtained by translating the language A into a language B. For another example, the target audio is an audio completely unrelated to the audio in the first video, which may be specifically and flexibly set. In practical applications, a duration of the target audio may be equal to a speaking duration of the target object in the first video. Exemplarily, the first video is completely a speaking video of the target object, for example, the first video may be an interview video, a voice-over video, etc. That is, if each original frame image in the first video contains the target face, the duration of the target audio is equal to a duration of the first video. After acquiring the first video and the target audio, the embodiment of the present disclosure processes the first video and the target audio with an aim of obtaining a new video in which the lip movement of the target face in the first video matches the target audio.

Step S104: determining, based on the target audio, target key points in a to-be-generated target frame image corresponding to an original frame image in the first video, where the target key points are key points of the target face in the to-be-generated target frame image.

The original frame image in the first video specifically refers to each frame of image included in the first video, that is, for each original frame image included in the first video, the target key points (also referred to as first key points) in the target frame image corresponding to the original frame image are determined based on the target audio. Specifically, in the target audio, audio content corresponding to the original frame image may be determined based on a time point of the original frame image in the first video, so as to determine a facial expression such as a lip movement corresponding to the audio content, thereby determining the key points of the target face in the to-be-generated target frame image (also referred to as result frame image) and obtaining the target key points. In practical applications, the target key points may be determined by using a lip movement driving algorithm such as a Blendshape algorithm based on the target audio, and the target key points are the key points of the target face in the to-be-generated target frame image. In other words, the target key points may be used to generate the target face in the target frame image, so that the lip movement of the face in the generated image presents a visual effect of matching the new audio.

Step S106: generating a first image and a second image corresponding to the original frame image based on the first video and the target key points, where the first image carries information of a complete facial region of the target face, and the second image carries information of an occluder corresponding to the target face.

The first image may be an image obtained by fusing part of original frame images in the first video. Exemplarily, an original frame image in which the face is fully unoccluded may be first selected from the first video, and then the selected original frame images are fused, so as to obtain the first image carrying the information of the complete facial region of the target face for subsequent reference in facial generation. In addition, for each original frame image in the first video, the embodiment of the present disclosure may further generate a corresponding second image for the original frame image, and the second image carries information of the occluder of the target face in the original frame image. Any object that occludes the target face may be used as the occluder, such as a hand, a water cup, a book, a doll, etc., which is not limited herein. The embodiment of the present disclosure fully considers the influence of the occluder on facial generation, and therefore an additional second image is generated for each original frame image. In addition, it should be noted that if there is no occluder on the target face in a certain original frame image, the information of the occluder corresponding to the target face carried in the corresponding second image is empty or default.

Step S108: generating the target frame image corresponding to the original frame image based on the first image and the second image corresponding to the original frame image.

For each original frame image in the first video, a corresponding target frame image may be generated based on the unified first image and the second image corresponding to the original frame image, where the first image may be used to provide complete facial information, so as to avoid facial features from being affected by the occluder, and the second image may provide corresponding occluder information. Therefore, it is comprehensively ensured that the finally generated target frame image may not only accurately present the information of the occluder, but also present the information of the unoccluded area of the face in a better way.

Step S110: arranging the target frame images corresponding to respective original frame images in the first video, in sequence, to obtain a target video.

Each original frame image has a corresponding target frame image, and the target frame images corresponding to all the original frame images may be arranged based on an arrangement order of the original frame images in the first video, so as to obtain the target video (also referred to as result video).

The embodiment of the present disclosure fully considers that the face may sometimes be occluded when a person is speaking, and the above technical solution provided by the embodiment of the present disclosure facilitates ensuring that the unoccluded part of the face in the generated target video may be generated normally without being affected by the occluder, and ensuring that the occluder is generated normally. Therefore, problems in the related art, such as severe occlusion deformation and degradation of facial generation quality caused by the influence of the occluder, may be effectively alleviated.

In some implementations, the above step S106, that is, the step of generating the first image and the second image corresponding to the original frame image based on the first video and the target key points, may be performed with reference to the following steps A to C.

Step A: selecting a plurality of reference frame images from the first video, and acquiring reference key points of the target face in the reference frame images, where the target face in the reference frame images is fully unoccluded. A number of the reference frame images may be flexibly set, for example, may be set to 20 to 30, which is not limited herein. In practical applications, a 3D facial model may be constructed by a method such as a facial reconstruction algorithm, and then the reference key points of the target face are generated based on the 3D facial model. The reference key points are key points of the target face in the reference frame images, and the number of the reference key points is the same as that of the aforementioned target key points, and the reference key points have a one-to-one correspondence with the target key points.

Exemplarily, the above step of selecting the plurality of reference frame images from the first video may be performed with reference to the following (1) to (3).
(1): performing occluder detection processing on the first video to obtain an occluder detection result corresponding to the original frame image in the first video. Specifically, a corresponding detection algorithm may be used to perform occluder detection processing on the original frame image of the first video, so as to determine whether there is an occluded area on the target face in the original frame image, thereby obtaining the occluder detection result corresponding to the original frame image. The occluder detection result may be at least used to indicate whether there is an occluder on the target face, and may further indicate position information of the occluder on the target face.
(2): selecting, based on the occluder detection result corresponding to the original frame image, an original frame image in which the target face is fully unoccluded as a candidate frame image. It may be understood that in the first video, there may be many original frame images in which the target face is fully unoccluded, so these original frame images may be preliminarily selected as the candidate frame images for subsequent further selection.
(3): selecting, based on the lip movement information of the target face in the candidate frame image, a plurality of reference frame images with different lip movements from the candidate frame images. In practical applications, a plurality of reference frame images with different lip movements may be selected by means of uniform sampling or the like based on the lip movement information of the target face in the candidate frame images, or a plurality of lip movement categories covered by the candidate frame images may be determined based on the lip movement information of the target face in the candidate frame images, and then at least one candidate frame image is selected, as a reference frame image, from the candidate frame images corresponding to each lip movement category. The number of reference frame images selected from different lip movement categories may be the same or different, which may be specifically and flexibly set. Through the above method, a plurality of reference frame images with different lip movements may be acquired, which facilitates a more comprehensive and reasonable subsequent fusion of the plurality of reference frame images.

Step B: fusing the plurality of reference frame images based on the target key points and the reference key points to obtain the first image. As mentioned above, the target key points have some correspondence with the reference key points, and the plurality of reference frame images may cover different lip movements. With different lip movements, there are also certain differences in presented facial features accordingly. By means of fusion, it enables the obtained first image to present the features of the target face more richly and comprehensively. In some specific implementations, step B may be performed with reference to the following steps B1 to B3.

Step B1: acquiring deformation information and weights respectively corresponding to the plurality of reference frame images based on the target key points and the reference key points, where the deformation information of the reference frame images is used to indicate a mapping relationship between the target face in the reference frame images and the target face in the target frame image corresponding to the reference frame images. Specifically, the deformation information corresponding to the target face in the plurality of reference frame images may be generated based on the target key points of the target frame image corresponding to the plurality of reference frame images and the reference key points of the plurality of reference frame images, and the deformation information may be used to perform deformation processing on the reference frame images, so as to align the reference key points in the reference frame images with the target key points in the target frame image, so that the reference frame images may be converted into the target frame image. The deformation information may also be referred to as a deformation flow, which may be represented by vector field information, for example. The above weights may also be related to the deformation information, for example, may depend on a deviation between the target key points and the corresponding reference key points. For the specific calculation method of the above deformation information and weights, reference may be made to the related art, which will not be repeated here.

Step B2: performing grid sampling processing on the reference frame images based on the deformation information corresponding to the reference frame images to obtain deformed images corresponding to the reference frame images. For example, based on the deformation information represented by the vector field, the reference frame images may be converted into the deformed images through the above method, and the deformed images are RGB images, for example.

Step B3: performing weighted fusion processing on the deformed images respectively corresponding to the plurality of reference frame images based on the weights respectively corresponding to the plurality of reference frame images to obtain the first image. For example, for each pixel point in the first image, a pixel value of the pixel point is equal to a value obtained by weighting pixel values corresponding to the pixel point in each of the reference frame images.

Through the above method, it enables the first image to present the complete information of the target face more objectively and comprehensively.

Step C: generating the second image corresponding to the original frame image in the first video based on the target key points and the original frame image. In some specific implementations, step C may be performed with reference to the following steps C1 to C2.

Step C1: acquiring deformation information corresponding to the original frame image in the first video based on the target key points corresponding to the original frame image, where the deformation information is used to indicate a mapping relationship between the occluder in the original frame image and the occluder in the target frame image corresponding to the original frame image, and a mapping relationship between an unoccluded facial region in the original frame image and an unoccluded facial region in the target frame image corresponding to the original frame image. The above deformation information may also be represented by vector field information.

Step C2: performing grid sampling processing on the original frame image based on the deformation information corresponding to the original frame image to obtain the second image corresponding to the original frame image. That is, based on the deformation information corresponding to the original frame image, the original frame image may be converted into the second image carrying the information of the occluder corresponding to the target face and the information of the area of the target face that is not occluded by the occluder. It should be noted that if the target face in the original frame image is not occluded, the target face in the second image will not be occluded either, and the information of the occluder corresponding to the target face carried in the second image is empty or default.

In some implementations, the above step S108, that is, the step of generating the target frame image corresponding to the original frame image based on the first image and the second image corresponding to the original frame image, may be performed with reference to the following steps a to c.

Step a: acquiring a mask frame image corresponding to the original frame image, where the mask frame image is an image obtained by performing local masking processing on the target face in the original frame image. An area of the local mask may be flexibly set according to requirements, for example, the lower half of the target face in the original frame image may be set to be masked.

Step b: performing fusion processing based on the first image, the mask frame image corresponding to the original frame image, and the second image corresponding to the original frame image to obtain a fusion processing result. The first image may be mainly used to provide the complete facial feature information, the second image may be mainly used to provide the occluder information corresponding to the target face and the facial information not occluded by the occluder, and the mask frame image may be mainly used to remove interference information. By fusing the above three types of images, the obtained fusion processing result may be represented by an image. The achieved effect is that even if there is an occluder, the unoccluded part of the target face and the occluder corresponding to the target face may be generated normally, which may effectively alleviate the problems in the related art, such as severe occlusion deformation and degradation of facial generation quality, caused by directly generating the face without considering the influence of the occluder.

In some implementations, step b may be performed with reference to the following steps b1 to b3.

Step b1: extracting a target facial feature (also referred to as first facial feature) based on the first image and the mask frame image corresponding to the original frame image. In practical applications, a neural network may be used to extract the target facial feature, and the mask frame image facilitates eliminating interference and makes it easier for the network to learn, thereby further improving the reliability of the target facial feature extracted by the network.

Step b2: extracting a specified feature based on the second image corresponding to the original frame image, where the specified feature includes at least an occluder feature, the second image further carries information of an unoccluded facial region of the target face, and the specified feature further includes a feature of the unoccluded facial region of the target face.

Step b3: performing multi-scale fusion processing on the target facial feature and the specified feature based on spatially adaptive normalization technology to obtain the fusion processing result. The spatially adaptive normalization technology may be implemented through a spatially adaptive normalization network, which may adaptively adjust normalization parameters and generate spatially adaptive scaling and offset parameters. Such parameters may act on different spatial positions of the feature map during the normalization process. Specifically, adaptive parameters for spatial dimension may also be introduced, so as to better retain information such as a spatial structure, thereby comprehensively ensuring the reliability of the fusion processing result.

In some specific implementations, when step b3 is specifically performed, the fusion processing result may be generated based on the target facial feature and the specified feature by using a plurality of first networks and a plurality of second networks that are preset and connected in sequence, where the first networks and the second networks are all spatially adaptive normalization networks, input information of the first networks and the second networks all include the target facial feature, input information of a non-first first network further includes an output result of a previous network of the non-first first network, and input information of the second networks further includes an output result of a previous network of the second networks and the specified feature. For ease of understanding, reference may be made to a schematic structural diagram of a fusion network shown in FIG. 2, where two first networks and two second networks are used as an example for illustration. The input information of each non-first first network and each non-first second network includes the output result of the previous network, the complete target facial feature is input to each network, and the specified feature (including the occluder feature and the feature of the unoccluded facial region of the target face) may only be input to the second networks, so as to better process the occluder feature subsequently. It should be noted that FIG. 2 is only an example, and the number of the first networks and the second networks may be flexibly set in practical applications. Through the above method, multi-scale feature fusion may be implemented, and the richness and comprehensiveness of the finally obtained fusion processing result may be effectively ensured.

Step c: obtaining the target frame image corresponding to the original frame image based on the fusion processing result. Exemplarily, the fusion processing result is represented by the third image, and the third image may present the unoccluded target facial feature matching the content of the target audio and the occluder feature corresponding to the target face, and may also present, for example, the original background feature. In some implementations, the third image may be directly used as the target frame image, and in other implementations, the third image may be optimized to obtain the target frame image corresponding to the original frame image. That is, the optimized third image is used as the target frame image. The optimization processing may include, for example, facial blemish removal processing, and the blemishes include but are not limited to the discontinuity between the occluder and the face. In practical applications, the third image may be optimized by means of an encoder or the like, and in this way, the generation quality of the target frame image may be further improved, and a better visual effect of the target frame image may be ensured.

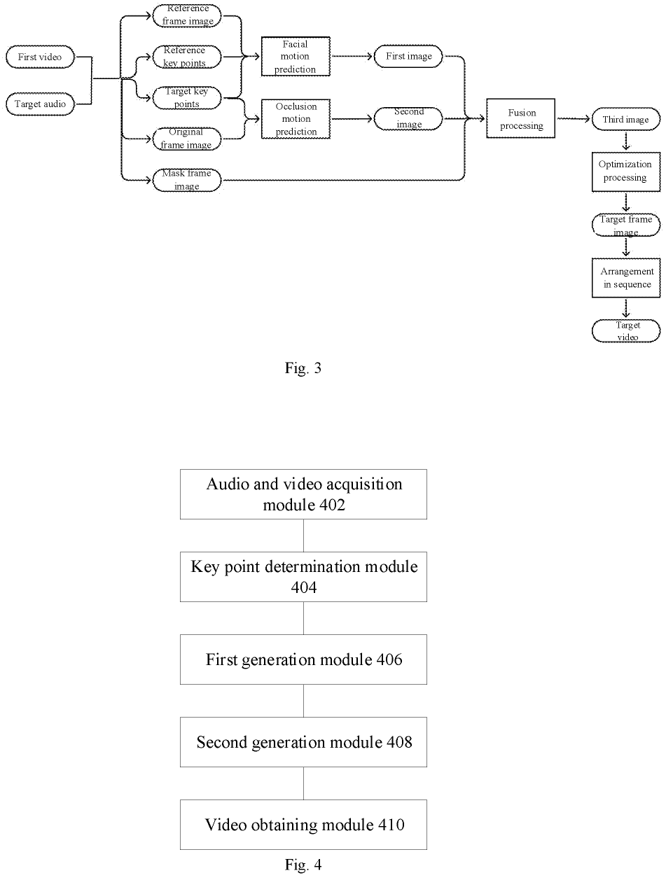

For ease of understanding, reference may also be made to a schematic flowchart of a video generation method shown in FIG. 3, which illustrates that the reference frame images, the reference key points, the target key points, the original frame image and the mask frame image may be obtained first based on the input first video and the input target audio. For the specific determination method, reference may be made to the above related content. Then, facial motion prediction processing is performed based on the reference frame images, the reference key points and the target key points, so as to generate the first image. For the execution process of the facial motion prediction processing, reference may be made to the above steps B1 to B3. In addition, occlusion motion prediction processing is performed based on the target key points and the original frame image, so as to generate the second image. For the execution process of the occlusion motion prediction processing, reference may be made to the above steps C1 to C2. Then, the fusion processing is performed based on the first image, the second image and the mask frame image to obtain the third image. For the execution process of the fusion processing, reference may be made to the above steps b1 to b3. Subsequently, the third image may be optimized by an encoding method such as an encoder, so as to obtain the target frame image. Based on the arrangement order of the original frame images, the target frame images corresponding to the respective original frame images in the first video are arranged in sequence, so as to obtain the target video. The target video mainly changes the lip movement and other facial features of the target face in the first video based on the target audio, so that the lip movement and other facial features of the target face match the content of the target video, and in the case that the target face is occluded, the occluder and the unoccluded area of the target face may also be accurately presented.

In practical applications, the above video generation method is performed by a preset target network model, and for example, the aforementioned fusion network and the like all belong to networks included in the target network model. The embodiment of the present disclosure provides a training method by taking the overall target network model as an example. Exemplarily, the target network model is obtained by training through the following steps 1 to 3.

Step 1: acquiring a sample video and a sample audio, and preprocessing the sample video, where the preprocessing includes: performing occluder adding processing on part of reference frame images corresponding to the sample video, and/or performing occluder adding processing on at least part of original frame images in the sample video. For example, an occluder may be added, with a certain probability, to the reference frame images, and/or, an occluder may be added to the original frame images.

Step 2: acquiring a first image and a target frame image generated by a preset initial generation model based on the sample audio and the preprocessed sample video. For the specific method of acquiring the first image and the target frame image, reference may be made to the above related content, which will not be repeated here.

Step 3: performing supervised training based on the first image and the target frame image generated by the initial generation model to obtain the target network model based on the trained initial generation model. For example, in the case that the occluder adding processing is performed on part of the reference frame images corresponding to the sample video, it may be supervised that the first image generated by the model is kept unchanged, that is, it is ensured as much as possible that the first image with the complete face information generated by the model may not be affected by the occluder. In addition, in the case that the occluder adding processing is performed on at least part of the original frame images in the sample video, it may be supervised that the occluder area of the target frame image generated by the model is kept unchanged. In practical applications, a first loss corresponding to the first image and a second loss corresponding to the target frame image may be acquired, and a total loss is determined based on the first loss and the second loss. The training is ended after the total loss converges to a preset threshold. Through the above method, the trained initial generation model may accurately perceive the facial occluder, ensure that the unoccluded part of the face in the generated target frame image may be generated normally without being affected by the occluder, and ensure that the occluder is generated normally. In this way, stronger occlusion robustness is achieved.

In practical applications, the trained initial generation model may be directly used as the target network model, or other functional modules may be additionally added on the basis of the trained initial generation model, and then the target network model is obtained, which may be specifically and flexibly set and is not limited herein.

To sum up, according to the above method provided by the embodiment of the present disclosure, it is fully considered that the face may sometimes be occluded when a person is speaking. In the scenario that the target face of the original first video is regenerated based on the target audio to obtain the target video with the lip movement matching the target audio, the occluder may be additionally modeled. In the case that the face is occluded, it may also be effectively ensured that the unoccluded part of the face in the generated target video may be generated normally without being affected by the occluder, and that the occluder is generated normally, so that problems in the related art, such as severe occlusion deformation and degradation of facial generation quality caused by the influence of the occluder, may be effectively alleviated, thereby comprehensively ensuring the generation quality and visual perception of the finally obtained target video, and effectively improving the user experience.

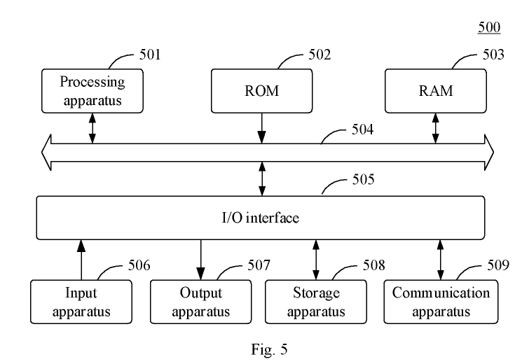

Corresponding to the aforementioned video generation method, an embodiment of the present disclosure further provides a video generation apparatus. FIG. 4 is a schematic structural diagram of a video generation apparatus according to an embodiment of the present disclosure. The apparatus may be implemented by software and/or hardware, and may generally be integrated in an electronic device. As shown in FIG. 4, the video generation apparatus includes:

an audio and video acquisition module 402, configured to acquire a first video and a target audio, where the first video is a video including a target face;

a key point determination module 404, configured to determine, based on the target audio, target key points in a to-be-generated target frame image corresponding to an original frame image in the first video, where the target key points are key points of the target face in the to-be-generated target frame image;

a first generation module 406, configured to generate a first image and a second image corresponding to the original frame image based on the first video and the target key points, where the first image carries information of a complete facial region of the target face, and the second image carries information of an occluder corresponding to the target face;

a second generation module 408, configured to generate the target frame image corresponding to the original frame image based on the first image and the second image corresponding to the original frame image; and

a video obtaining module 410, configured to arrange the target frame images corresponding to respective original frame images in the first video, in sequence, to obtain a target video.

The above apparatus facilitates ensuring that the unoccluded part of the face in the generated target video may be generated normally without being affected by the occluder, and ensuring that the occluder is generated normally, so that problems in the related art, such as severe occlusion deformation and degradation of facial generation quality caused by the influence of the occluder, may be effectively alleviated.

In some implementations, the first generation module 406 is further configured to: select a plurality of reference frame images from the first video, and acquire reference key points of the target face in the reference frame images, where the target face in the reference frame images is fully unoccluded; fuse the plurality of reference frame images based on the target key points and the reference key points to obtain the first image; and generate the second image corresponding to the original frame image in the first video based on the target key points and the original frame image.

In some implementations, the first generation module 406 is further configured to: perform occluder detection processing on the first video to obtain an occluder detection result corresponding to the original frame image in the first video; select, based on the occluder detection result corresponding to the original frame image, an original frame image in which the target face is fully unoccluded as a candidate frame image; and select, based on lip movement information of the target face in the candidate frame image, a plurality of reference frame images with different lip movements from the candidate frame image.

In some implementations, the first generation module 406 is further configured to: acquire deformation information and weights respectively corresponding to the plurality of reference frame images based on the target key points and the reference key points, where the deformation information of the reference frame images is used to indicate a mapping relationship between the target face in the reference frame images and the target face in the target frame image corresponding to the reference frame images; perform grid sampling processing on the reference frame images based on the deformation information corresponding to the reference frame images to obtain deformed images corresponding to the reference frame images; and perform weighted fusion processing on the deformed images respectively corresponding to the plurality of reference frame images based on the weights respectively corresponding to the plurality of reference frame images to obtain the first image.

In some implementations, the first generation module 406 is further configured to: acquire deformation information corresponding to the original frame image in the first video based on the target key points corresponding to the original frame image, where the deformation information is used to indicate a mapping relationship between the occluder in the original frame image and the occluder in the target frame image corresponding to the original frame image, and a mapping relationship between an unoccluded facial region in the original frame image and an unoccluded facial region in the target frame image corresponding to the original frame image; and perform grid sampling processing on the original frame image based on the deformation information corresponding to the original frame image to obtain the second image corresponding to the original frame image.

In some implementations, the second generation module 408 is further configured to: acquire a mask frame image corresponding to the original frame image, where the mask frame image is an image obtained by performing local masking processing on the target face in the original frame image; perform fusion processing based on the first image, the mask frame image corresponding to the original frame image, and the second image corresponding to the original frame image to obtain a fusion processing result; and obtain the target frame image corresponding to the original frame image based on the fusion processing result.

In some implementations, the second generation module 408 is further configured to: extract a target facial feature based on the first image and the mask frame image corresponding to the original frame image; extract a specified feature based on the second image corresponding to the original frame image, where the specified feature includes at least an occluder feature; and perform multi-scale fusion processing on the target facial feature and the specified feature based on spatially adaptive normalization technology to obtain the fusion processing result.

In some implementations, the second generation module 408 is further configured to: generate the fusion processing result based on the target facial feature and the specified feature by using a plurality of first networks and a plurality of second networks that are preset and connected in sequence, where the first networks and the second networks are all spatially adaptive normalization networks, input information of the first networks and the second networks all include the target facial feature, input information of a non-first first network further includes an output result of a previous network of the non-first first network, and input information of the second networks further includes an output result of a previous network of the second networks and the specified feature.

In some implementations, the second image further carries information of an unoccluded facial region of the target face, and the specified feature further includes a feature of the unoccluded facial region of the target face.

In some implementations, the fusion processing result is represented by a third image, and the second generation module 408 is further configured to: optimize the third image to obtain the target frame image corresponding to the original frame image.

In some implementations, the video generation method is performed by a preset target network model, and the apparatus further includes a model training module, configured to obtain the target network model by training as follows: acquiring a sample video and a sample audio, and preprocessing the sample video, where the preprocessing includes: performing occluder adding processing on part of reference frame images corresponding to the sample video, and/or performing occluder adding processing on at least part of original frame images in the sample video; acquiring a first image and a target frame image generated by a preset initial generation model based on the sample audio and the preprocessed sample video; and performing supervised training based on the first image and the target frame image generated by the initial generation model to obtain the target network model based on the trained initial generation model.

The video generation apparatus provided by the embodiment of the present disclosure may perform the video generation method provided by any embodiment of the present disclosure, and has corresponding functional modules and beneficial effects for performing the method.

Those skilled in the art may clearly understand that, for the convenience and simplicity of description, for the specific working process of the apparatus embodiment described above, reference may be made to the corresponding process in the method embodiment, and details are not described herein again.

An embodiment of the present disclosure provides an electronic device. The electronic device includes: a storage apparatus, on which a computer program is stored; and a processing apparatus, configured to execute the computer program in the storage apparatus to implement the steps of any method in the present disclosure.

Reference is made to FIG. 5 below, which illustrates a schematic structural diagram of an electronic device 500 suitable for implementing an embodiment of the present disclosure. The terminal device in the embodiment of the present disclosure may include, but is not limited to, mobile terminals such as a mobile phone, a notebook computer, a digital broadcast receiver, a PDA (Personal Digital Assistant), a tablet computer, a PMP (Portable Media Player), a vehicle-mounted terminal (e.g., a vehicle-mounted navigation terminal), etc., and fixed terminals such as a digital television, a desktop computer, etc. The electronic device shown in FIG. 5 is only an example, and should not impose any limitation on the functions and the range of use of the embodiments of the present disclosure.

As shown in FIG. 5, the electronic device 500 may include a processing apparatus (e.g., a central processing unit, a graphics processing unit, etc.) 501, which may perform various appropriate actions and processing according to a program stored in a read-only memory (read-only memory, ROM) 502 or a program loaded from a storage apparatus 508 into a random-access memory (random-access memory, RAM) 503. The RAM 503 further stores various programs and data required for the operation of the electronic device 500. The processing apparatus 501, the ROM 502 and the RAM 503 are connected to each other through a bus 504. An input/output (I/O) interface 505 is also connected to the bus 504.

Usually, the following apparatuses may be connected to the I/O interface 505: an input apparatus 506 including, for example, a touch screen, a touchpad, a keyboard, a mouse, a camera, a microphone, an accelerometer, a gyroscope, etc.; an output apparatus 507 including, for example, a liquid crystal display (Liquid Crystal Display, LCD), a speaker, a vibrator, etc.; the storage apparatus 508 including, for example, a magnetic tape, a hard disk, etc.; and a communication apparatus 509. The communication apparatus 509 may allow the electronic device 500 to perform wireless or wired communication with other devices to exchange data. Although FIG. 5 shows the electronic device 500 having various apparatuses, it should be understood that it is not required to implement or provide all the apparatuses shown. Alternatively, more or fewer apparatuses may be implemented or provided.

In particular, according to the embodiment of the present disclosure, the process described above with reference to the flowchart may be implemented as a computer software program. For example, the embodiment of the present disclosure includes a computer program product, which includes a computer program carried on a non-transitory computer-readable medium, and the computer program includes program codes for performing the method shown in the flowchart. In such an embodiment, the computer program may be downloaded and installed from a network through the communication apparatus 509, or installed from the storage apparatus 508, or installed from the ROM 502. When the computer program is executed by the processing apparatus 501, the above functions defined in the method of the embodiment of the present disclosure are executed.

In addition to the above methods and devices, the embodiment of the present disclosure may also be a computer program product, which includes computer program instructions, and the computer program instructions, when run by a processor, cause the processor to execute the method provided by the embodiment of the present disclosure. The computer program product may be written in any combination of one or more programming languages to execute program codes for the operations of the embodiments of the present disclosure, and the programming languages include object-oriented programming languages such as Java, C++, etc., and also include conventional procedural programming languages such as "C" language or similar programming languages. The program codes may be executed entirely on a user computing device, partly on a user device, as a stand-alone software package, partly on a user computing device and partly on a remote computing device, or entirely on a remote computing device or a server.

In addition, the embodiment of the present disclosure may also be a computer-readable storage medium, on which computer program instructions are stored, and the computer program instructions, when run by a processor, cause the processor to execute the video generation method provided by the embodiment of the present disclosure.

The computer-readable storage medium may adopt any combination of one or more readable media. The readable medium may be a readable signal medium or a readable storage medium. The readable storage medium may include, for example, but is not limited to, an electronic, magnetic, optical, electromagnetic, infrared, or semiconductor system, apparatus, or device, or any suitable combination of the above. More specific examples (a non-exhaustive list) of the readable storage medium include: an electrical connection having one or more wires, a portable disk, a hard disk, a random-access memory, a read-only memory, an erasable programmable read-only memory, an optical fiber, a portable compact disk read-only memory, an optical storage device, a magnetic storage device, or any suitable combination of the above.

An embodiment of the present disclosure further provides a computer program product, including a computer program/instructions, and the video generation method in the embodiment of the present disclosure is implemented when the computer program/instructions are executed by a processor.

It may be understood that before using the technical solutions disclosed in the embodiments of the present disclosure, the user shall be informed of the type, range of use, use scenarios, etc. of personal information involved in the present disclosure in an appropriate manner and the authorization of the user shall be obtained according to relevant laws and regulations.

For example, in response to receiving an active request from a user, prompt information is sent to the user to clearly prompt the user that the requested operation will require access to and use of the user's personal information. In this way, the user may independently choose, based on the prompt information, whether to provide the personal information to software or hardware, such as an electronic device, an application, a server or a storage medium, that performs the operations of the technical solutions of the present disclosure.

As an optional but non-limiting implementation, in response to receiving the active request from the user, the prompt information may be sent to the user in the form of, for example, a pop-up window, and the prompt information may be presented in text in the pop-up window. In addition, the pop-up window may also carry a selection control for the user to choose whether to "agree" or "disagree" to provide the personal information to the electronic device.

It may be understood that the above process of notifying and acquiring user authorization is only illustrative and does not constitute a limitation on the implementations of the present disclosure, and other methods that satisfy the relevant laws and regulations may also be applied to the implementations of the present disclosure.

It should be noted that in this paper, relational terms such as "first" and "second" are only used to distinguish one entity or operation from another entity or operation, and do not necessarily require or imply any actual relationship or order between these entities or operations. Moreover, the terms "include", "include" or any other variation thereof are intended to cover a non-exclusive inclusion, so that a process, method, object or device including a series of elements includes not only those elements, but also other elements not explicitly listed or elements inherent to such process, method, object or device. Without further restrictions, an element defined by the phrase "includes a" does not exclude that there are other identical elements in the process, method, object or device that includes the element.

The above descriptions are only specific implementations of the present disclosure, so that those skilled in the art may understand or implement the present disclosure. Various modifications to these embodiments will be readily apparent to those skilled in the art, and the generic principles defined herein may be practiced in other embodiments without departing from the spirit or scope of the present disclosure. Therefore, the present disclosure will not be limited to the embodiments described herein, but is to be accorded the widest scope consistent with the principles and novel features disclosed herein.

1. A video generation method, comprising:
acquiring a first video and a first audio, wherein the first video is a video including a face;
determining, based on the first audio, first key points in a result frame image corresponding to an original frame image in the first video, wherein the first key points are key points of the face in the result frame image;
generating a first image and a second image corresponding to the original frame image based on the first video and the first key points, wherein the first image carries information of a complete facial region of the face, and the second image carries information of an occluder corresponding to the face;
generating the result frame image corresponding to the original frame image based on the first image and the second image corresponding to the original frame image; and
arranging the result frame images corresponding to respective original frame images in the first video, in sequence, to obtain a result video.

2. The method according to claim 1, wherein the generating a first image and a second image corresponding to the original frame image based on the first video and the first key points comprises:
selecting a plurality of reference frame images from the first video, and acquiring reference key points of the face in the reference frame images, wherein the face in the reference frame images is fully unoccluded;
fusing the plurality of reference frame images based on the first key points and the reference key points, to obtain the first image; and
generating the second image corresponding to the original frame image in the first video based on the first key points and the original frame image.

3. The method according to claim 2, wherein the selecting a plurality of reference frame images from the first video comprises:
performing occluder detection processing on the first video, to obtain an occluder detection result corresponding to the original frame image in the first video;
selecting, based on the occluder detection result corresponding to the original frame image, an original frame image in which the face is fully unoccluded as a candidate frame image; and
selecting, based on lip movement information of the face in the candidate frame image, a plurality of reference frame images with different lip movements from the candidate frame image.

4. The method according to claim 2, wherein the fusing the plurality of reference frame images based on the first key points and the reference key points, to obtain the first image comprises:
acquiring deformation information and weights respectively corresponding to the plurality of reference frame images based on the first key points and the reference key points, wherein the deformation information of the reference frame images is used to indicate a mapping relationship between the face in the reference frame images and the face in the result frame image corresponding to the reference frame images;
performing grid sampling processing on the reference frame images based on the deformation information corresponding to the reference frame images to obtain deformed images corresponding to the reference frame images; and
performing weighted fusion processing on the deformed images respectively corresponding to the plurality of reference frame images based on the weights respectively corresponding to the plurality of reference frame images, to obtain the first image.

5. The method according to claim 2, wherein the generating the second image corresponding to the original frame image in the first video based on the first key points and the original frame image comprises:
acquiring deformation information corresponding to the original frame image in the first video based on the first key points corresponding to the original frame image, wherein the deformation information is used to indicate a mapping relationship between the occluder in the original frame image and the occluder in the result frame image corresponding to the original frame image, and a mapping relationship between an unoccluded facial region in the original frame image and an unoccluded facial region in the result frame image corresponding to the original frame image; and
performing grid sampling processing on the original frame image based on the deformation information corresponding to the original frame image, to obtain the second image corresponding to the original frame image.

6. The method according to claim 1, wherein the generating the result frame image corresponding to the original frame image based on the first image and the second image corresponding to the original frame image comprises:
acquiring a mask frame image corresponding to the original frame image, wherein the mask frame image is an image obtained by performing local masking processing on the face in the original frame image;
performing fusion processing based on the first image, the mask frame image corresponding to the original frame image, and the second image corresponding to the original frame image, to obtain a fusion processing result; and
obtaining the result frame image corresponding to the original frame image based on the fusion processing result.

7. The method according to claim 6, wherein the performing fusion processing based on the first image, the mask frame image corresponding to the original frame image, and the second image corresponding to the original frame image, to obtain a fusion processing result comprises:
extracting a first facial feature based on the first image and the mask frame image corresponding to the original frame image;
extracting a specified feature based on the second image corresponding to the original frame image, wherein the specified feature comprises at least an occluder feature; and
performing multi-scale fusion processing on the first facial feature and the specified feature based on spatially adaptive normalization technology to obtain the fusion processing result.

8. The method according to claim 7, wherein the performing multi-scale fusion processing on the first facial feature and the specified feature based on spatially adaptive normalization technology to obtain the fusion processing result comprises:
generating the fusion processing result based on the first facial feature and the specified feature by using a plurality of first networks and a plurality of second networks that are preset and connected in sequence;
wherein the first networks and the second networks are all spatially adaptive normalization networks, input information of the first networks and the second networks both comprise the first facial feature, input information of a non-first first network further comprises an output result of a previous network of the non-first first network, and input information of the second networks further comprises an output result of a previous network of the second networks and the specified feature.

9. The method according to claim 7, wherein the second image further carries information of an unoccluded facial region of the face, and the specified feature further comprises a feature of the unoccluded facial region of the face.

10. The method according to claim 6, wherein the fusion processing result is represented by a third image, and
wherein the obtaining the result frame image corresponding to the original frame image based on the fusion processing result comprises:
optimizing the third image to obtain the result frame image corresponding to the original frame image.

11. The method according to claim 2, wherein the video generation method is performed by a preset network model, and the network model is obtained by training as follows:
acquiring a sample video and a sample audio, and preprocessing the sample video, wherein the preprocessing comprises at least one of: performing occluder adding processing on part of reference frame images corresponding to the sample video, or performing occluder adding processing on at least part of original frame images in the sample video;
acquiring a first image and a result frame image generated by a preset initial generation model based on the sample audio and the preprocessed sample video; and
performing supervised training based on the first image and the result frame image generated by the initial generation model, to obtain the network model based on a trained initial generation model.

12. An electronic device, comprising:
a storage apparatus, on which a computer program is stored; and
a processing apparatus, configured to execute the computer program in the storage apparatus to implement a video generation method, comprising:
acquiring a first video and a first audio, wherein the first video is a video including a face;
determining, based on the first audio, first key points in a result frame image corresponding to an original frame image in the first video, wherein the first key points are key points of the face in the result frame image;
generating a first image and a second image corresponding to the original frame image based on the first video and the first key points, wherein the first image carries information of a complete facial region of the face, and the second image carries information of an occluder corresponding to the face;
generating the result frame image corresponding to the original frame image based on the first image and the second image corresponding to the original frame image; and
arranging the result frame images corresponding to respective original frame images in the first video, in sequence, to obtain a result video.

13. The electronic device according to claim 12, wherein the generating a first image and a second image corresponding to the original frame image based on the first video and the first key points comprises:
selecting a plurality of reference frame images from the first video, and acquiring reference key points of the face in the reference frame images, wherein the face in the reference frame images is fully unoccluded;
fusing the plurality of reference frame images based on the first key points and the reference key points, to obtain the first image; and
generating the second image corresponding to the original frame image in the first video based on the first key points and the original frame image.

14. The electronic device according to claim 13, wherein the selecting a plurality of reference frame images from the first video comprises:
performing occluder detection processing on the first video, to obtain an occluder detection result corresponding to the original frame image in the first video;
selecting, based on the occluder detection result corresponding to the original frame image, an original frame image in which the face is fully unoccluded as a candidate frame image; and
selecting, based on lip movement information of the face in the candidate frame image, a plurality of reference frame images with different lip movements from the candidate frame image.

15. The electronic device according to claim 13, wherein the fusing the plurality of reference frame images based on the first key points and the reference key points, to obtain the first image comprises:
acquiring deformation information and weights respectively corresponding to the plurality of reference frame images based on the first key points and the reference key points, wherein the deformation information of the reference frame images is used to indicate a mapping relationship between the face in the reference frame images and the face in the result frame image corresponding to the reference frame images;
performing grid sampling processing on the reference frame images based on the deformation information corresponding to the reference frame images to obtain deformed images corresponding to the reference frame images; and
performing weighted fusion processing on the deformed images respectively corresponding to the plurality of reference frame images based on the weights respectively corresponding to the plurality of reference frame images, to obtain the first image.

16. The electronic device according to claim 13, wherein the generating the second image corresponding to the original frame image in the first video based on the first key points and the original frame image comprises:
acquiring deformation information corresponding to the original frame image in the first video based on the first key points corresponding to the original frame image, wherein the deformation information is used to indicate a mapping relationship between the occluder in the original frame image and the occluder in the result frame image corresponding to the original frame image, and a mapping relationship between an unoccluded facial region in the original frame image and an unoccluded facial region in the result frame image corresponding to the original frame image; and
performing grid sampling processing on the original frame image based on the deformation information corresponding to the original frame image, to obtain the second image corresponding to the original frame image.

17. The electronic device according to claim 12, wherein the generating the result frame image corresponding to the original frame image based on the first image and the second image corresponding to the original frame image comprises:
acquiring a mask frame image corresponding to the original frame image, wherein the mask frame image is an image obtained by performing local masking processing on the face in the original frame image;
performing fusion processing based on the first image, the mask frame image corresponding to the original frame image, and the second image corresponding to the original frame image, to obtain a fusion processing result; and
obtaining the result frame image corresponding to the original frame image based on the fusion processing result.

18. The electronic device according to claim 17, wherein the performing fusion processing based on the first image, the mask frame image corresponding to the original frame image, and the second image corresponding to the original frame image, to obtain a fusion processing result comprises:
extracting a first facial feature based on the first image and the mask frame image corresponding to the original frame image;
extracting a specified feature based on the second image corresponding to the original frame image, wherein the specified feature comprises at least an occluder feature; and
performing multi-scale fusion processing on the first facial feature and the specified feature based on spatially adaptive normalization technology to obtain the fusion processing result.

19. The electronic device according to claim 18, wherein the performing multi-scale fusion processing on the first facial feature and the specified feature based on spatially adaptive normalization technology to obtain the fusion processing result comprises:
generating the fusion processing result based on the first facial feature and the specified feature by using a plurality of first networks and a plurality of second networks that are preset and connected in sequence;
wherein the first networks and the second networks are all spatially adaptive normalization networks, input information of the first networks and the second networks both comprise the first facial feature, input information of a non-first first network further comprises an output result of a previous network of the non-first first network, and input information of the second networks further comprises an output result of a previous network of the second networks and the specified feature.

20. A non-transient computer-readable storage medium, wherein a computer program is stored on the storage medium, and the computer program is configured to perform a video generation method, comprising:
acquiring a first video and a first audio, wherein the first video is a video including a face;
determining, based on the first audio, first key points in a result frame image corresponding to an original frame image in the first video, wherein the first key points are key points of the face in the result frame image;
generating a first image and a second image corresponding to the original frame image based on the first video and the first key points, wherein the first image carries information of a complete facial region of the face, and the second image carries information of an occluder corresponding to the face;
generating the result frame image corresponding to the original frame image based on the first image and the second image corresponding to the original frame image; and
arranging the result frame images corresponding to respective original frame images in the first video, in sequence, to obtain a result video.
